(19) United States
(12) Patent Application Publication
(10) Pub. No.: US 2021/0276219 A1
(43) Pub. Date: Sep. 9, 2021

(54) PROCESS FOR TREATING A WOOD SUBSTRATE AND WATER-BASED WOOD TREATMENT SOLUTION AND KIT ASSOCIATED THEREWITH

(71) Applicant: ADAPTIVA INNOVATIONS INC., Matane (Quebec) (CA)

(72) Inventors: THOMAS THIBAULT, MATANE (QUEBEC) (CA); VICTORIA TONG, MATANE (QUEBEC) (CA)

(21) Appl. No.: 17/130,833

(22) Filed: Dec. 22, 2020

Related U.S. Application Data
(60) Provisional application No. 62/984,333, filed on Mar. 3, 2020.

(51) Int. Cl. B27K 5/02; B05D 7/06; B05D 7/24

(52) U.S. Cl. CPC B27K 5/02; B05D 2401/20; B05D 7/24; B05D 7/06

(57) ABSTRACT

The present description relates to processes, water-based wood treatment solutions and kits for treating wood substrates so as to obtain colored (or altered) wood substrates, where mineral compounds that impart the color or other desirable characteristic(s) to the wood substrates are formed in the colored or altered wood substrates. The mineral compounds formed comprise the products of a chemical reaction which occurs between the wood substrate, a metal salt, and an oxygen source.

### RELATED APPLICATION

This application claims priority under applicable laws to U.S. provisional application No. 62/984,333 filed on Mar. 3, 2020, the content of which is incorporated herein by reference in its entirety for all purposes.

### TECHNICAL FIELD

The present disclosure relates to processes, water-based wood treatment solutions and kits for treating wood substrates. More particularly, the present disclosure relates to processes, water-based wood treatment solutions and kits for rapidly coloring wood substrates to mimic the appearance of aged wood substrate.

### BACKGROUND

Oxidation is a natural process that wood undergoes as it ages. Over time, the exposure to oxygen and UV rays from the sun causes a wooden board to either lighten or darken, depending on the wood species. Repeated changes in moisture and exposure to elements like wind and rain can also accelerate the aging of wood.

Although the wood surface is damaged in the process, an aged barn door or weathered beam can be appealing. Indeed, obtaining a vintage look is something which many people desire, as aged wood is a popular material used for both interior and exterior applications. However, obtaining a wood substrate with an already rustic look can be long, difficult and expensive.

It is already known in the art to accelerate the natural oxidation of a wood substrate. For example, it is already known that mixing steel wool into vinegar creates ferrous and ferric acetate in solution, which, once applied to the surface of a wood substrate, can color it to provide it with an aging effect.

Even though the combination of steel wool and vinegar as an artificial ageing solution is already known in the art, this approach presents several drawbacks. For example, reaching complete dissolution of the steel wool in the vinegar can take several days. Moreover, the nature and concentrations of the reactive species (in the steel wool for example) are unknown, which can lead to different end results using different quantities and brands of steel wool and vinegar. In addition, the solution obtained has an unpleasant odor and precipitates, which could bring unwanted deposits once applied to the wood substrate.

There is therefore a need for improved processes, water-based wood treatment solutions and kits for rapidly coloring wood substrates so as to mimic the appearance of aged wood substrate, and which, by virtue of their steps or components, would be able to overcome or at least minimize some of the above-discussed concerns.

### SUMMARY

It is an object of the present disclosure to provide processes, water-based wood treatment solutions and kits for treating wood substrates that overcome or mitigate one or more disadvantages of known processes, wood treatment solutions and kits for treating wood substrates, or at least provide useful alternatives.

In accordance with an embodiment, there is provided a kit for treating a wood substrate, the kit comprising: a pouch comprising a water-soluble metal (II) salt in solid form; a pouch comprising a water-soluble acetate salt in solid form; a pouch comprising a water-soluble tannin-rich material in solid form; and a user guide providing instructions for dissolving a dose of the water-soluble metal (II) salt and a dose of the water-soluble acetate salt in an amount of an aqueous solvent to thereby obtain a water-based wood treatment solution having a concentration of water-soluble metal (II) salt and water-soluble acetate salt sufficient to allow the water-based wood treatment solution to color the wood substrate, and instructions: for dissolving a dose of the water-soluble tannin-rich material in the aqueous solvent along with the water-soluble metal (II) salt and the water-soluble acetate salt; or for dissolving a dose of the water-soluble tannin-rich material in another aqueous solvent to thereby obtain a water-based tannin-rich treatment solution having a concentration of water-soluble tannin-rich material sufficient to allow the water-based tannin-rich treatment solution to at least partially saturate the wood substrate.

In one implementation, the water-soluble metal (II) salt and the water-soluble acetate salt are provided in form of solid powders.

In one implementation, the water-soluble tannin-rich material are provided in form of solid powders.

In one implementation, at least the pouch comprising the water-soluble metal (II) salt and the pouch comprising the water-soluble acetate salt are hermetic pouches.

In one implementation, the water-soluble metal (II) salt comprises a water-soluble iron (II) salt. The water-soluble iron (II) salt can comprise an iron (II) chloride, an iron (II) perchlorate, an iron (II) sulfate, or any combination thereof. More particularly, the water-soluble iron (II) salt can comprise an iron (II) sulfate monohydrate, an iron (II) sulfate heptahydrate, an iron (II) ethylenediammonium sulfate, or any combination thereof. For example, the water-soluble iron (II) salt can be iron (II) sulfate heptahydrate.

In one implementation, the concentration of the water-soluble metal (II) salt in the water-based wood treatment solution is between about 1 g/L and about 10 g/L, between about 1.5 g/L and about 7 g/L, between about 2 g/L and about 5 g/L or between about 2 g/L and about 3 g/L.

In one implementation, the water-soluble acetate salt comprises a sodium acetate, a calcium diacetate x-hydrate, or any combination thereof. For example, the sodium acetate can comprise sodium acetate trihydrate.

In one implementation, the concentration of the water-soluble acetate salt in the water-based wood treatment solution is between about 1 g/L and about 10 g/L, between about 2 g/L and about 5 g/L or between about 2 g/L and about 3 g/L.

In one implementation, the aqueous solvent is water.

In one implementation, the pH of the water-based wood treatment solution is adjusted to between about 4 and about 7, between about 5 and about 6 or between about 4 and about 5.

In one implementation, the water-soluble tannin-rich material has a tannin content greater than 40%, greater than 50%, greater than 60%, greater than 70%, greater than 80%, or greater than 90%.

In one implementation, the water-soluble tannin-rich material comprises a logwood tree extract, a mimosa tree extract, an oak gall extract, a tea extract, a wine extract, a coffee extract, or any combination thereof.

In one implementation, the concentration of the water-soluble tannin-rich material in the water-based wood treatment solution is between about 2 g/L and about 100 g/L, or between about 2 g/L and about 50 g/L.

In one implementation, the concentration of the water-soluble tannin-rich material in the water-based tannin-rich treatment solution is between about 2 g/L and about 25 g/L or between about 2 g/L and about 5 g/L.

In one implementation, the kit further comprises a pouch comprising a water-soluble acid in solid form; wherein the user guide further provides instructions for dissolving a dose of the water-soluble acid in the aqueous solvent along with the water-soluble metal (II) salt and the water-soluble acetate salt so as to adjust the pH of the water-based wood treatment solution.

In one implementation, the molar ratio of the water-soluble acid, the water-soluble metal (II) salt and the water-soluble acetate salt in the water-based wood treatment solution is between about 1:3:6 and about 1:3:30.

In one implementation, the water-soluble acid is provided in form of solid powders. The water-soluble acid can comprise a sulfuric acid, an acetic acid, a citric acid, or any combination thereof. For example, the citric acid can comprise an anhydrous citric acid.

In accordance with another embodiment, there is provided a process for treating a wood substrate comprising the steps of: providing a first aqueous solvent; dissolving a water-soluble metal (II) salt in solid form and a water-soluble acetate salt in solid form in the first aqueous solvent to obtain a water-based wood treatment solution, the water-soluble metal (II) salt and the water-soluble acetate salt being added in the first aqueous solvent in sufficient concentration to allow the water-based wood treatment solution to color the wood substrate; and one of: dissolving a water-soluble tannin-rich material in solid form in the first aqueous solvent together with the water-soluble metal (II) salt and the water-soluble acetate salt; and contacting the wood substrate with the water-based wood treatment solution for a contact time sufficient to color the wood substrate; and dissolving a water-soluble tannin-rich material in solid form in a second aqueous solvent to obtain a water-based tannin-rich treatment solution, the water-soluble tannin-rich material being added in the second aqueous solvent in sufficient concentration to allow the water-based tannin-rich treatment solution to at least partially saturate the wood substrate; contacting the wood substrate with the water-based tannin-rich treatment solution to at least partially saturate the wood substrate; and contacting the wood substrate with the water-based wood treatment solution for a contact time sufficient to color the wood substrate.

In one implementation, the wood substrate is contacted with the water-based tannin-rich treatment solution prior to or after the wood substrate has been contacted with the water-based wood treatment solution.

In one implementation, the wood substrate is first contacted with the water-based tannin-rich treatment solution to obtain a pretreated wood substrate, and then the pretreated wood substrate is contacted with the water-based wood treatment solution.

In one implementation, the process further comprises: preventing direct contact between the water-soluble metal (II) salt and the water-soluble acetate salt prior to dissolving the water-soluble metal (II) salt and the water-soluble acetate salt in the first aqueous solvent.

In one implementation, the water-soluble metal (II) salt and the water-soluble acetate salt are in the form of solid powders.

In one implementation, the water-soluble tannin rich material is in the form of solid powders.

In one implementation, the water-soluble metal (II) salt comprises a water-soluble iron (II) salt.

In one implementation, the water-soluble iron (II) salt comprises an iron (II) chloride, an iron (II) perchlorate, an iron (II) sulfate, or any combination thereof. More particularly, the water-soluble iron (II) salt can comprise an iron (II) sulfate monohydrate, an iron (II) sulfate heptahydrate, an iron (II) ethylenediammonium sulfate, or any combination thereof. For example, the water-soluble iron (II) salt can be iron (II) sulfate heptahydrate.

In one implementation, the concentration of the water-soluble metal (II) salt in the water-based wood treatment solution is between about 1 g/L and about 10 g/L, between about 1.5 g/L and about 7 g/L, between about 2 g/L and about 5 g/L or between about 2 g/L and about 3 g/L.

In one implementation, the water-soluble acetate salt comprises a sodium acetate, a calcium diacetate x-hydrate, or any combination thereof. For example, the sodium acetate can comprise sodium acetate trihydrate.

In one implementation, the concentration of the water-soluble acetate salt in the water-based wood treatment solution is between about 1 g/L and about 10 g/L, between about 2 g/L and about 5 g/L or between about 2 g/L and about 3 g/L.

In one implementation, the first aqueous solvent is water.

In one implementation, the second aqueous solvent is also water.

In one implementation, the water-soluble tannin-rich material has a tannin content greater than 40%, greater than 50%, greater than 60%, greater than 70%, greater than 80%, or greater than 90%.

In one implementation, the water-soluble tannin-rich material comprises a logwood tree extract, a mimosa tree extract, an oak gall extract, a tea extract, a wine extract, a coffee extract, or any combination thereof.

In one implementation, the concentration of the water-soluble tannin-rich material in the water-based wood treatment solution is between about 2 g/L and about 100 g/L, or between about 2 g/L and about 50 g/L.

In one implementation, the concentration of the water-soluble tannin-rich material in the water-based tannin-rich treatment solution is between about 2 g/L and about 25 g/L or between about 2 g/L and about 5 g/L.

In one implementation, the process further comprises the step of: dissolving a water-soluble acid is solid form in the first aqueous solvent before contacting the wood substrate with the water-based wood treatment solution.

In one implementation, the molar ratio of the water-soluble acid, the water-soluble metal (II) salt, and the water-soluble acetate salt in the water-based wood treatment solution is between about 1:3:6 and about 1:3:30.

In one implementation, the water-soluble acid is in the form of solid powders.

In one implementation, the water-soluble acid is added in a quantity such that the pH of the water-based wood treatment solution is between about 4 and about 7, between about 5 and about 6 or between about 4 and about 5.

In one implementation, the water-soluble acid comprises a sulfuric acid, an acetic acid, a citric acid, or any combination thereof. For example, the citric acid can comprise an anhydrous citric acid.

In accordance with a further embodiment, there is provided a kit for treating a wood substrate, the kit comprising: a pouch comprising a water-soluble tannin-rich material in solid form; and a user guide providing instructions for dissolving a dose of the water-soluble tannin-rich material in an aqueous solvent to thereby obtain a water-based tannin-rich treatment solution having a concentration of water-soluble tannin-rich material sufficient to allow the water-based tannin-rich treatment solution to at least partially saturate the wood substrate.

In one implementation, the water-soluble tannin-rich material is provided in form of solid powders.

In one implementation, the water-soluble tannin-rich material comprises a logwood tree extract, a mimosa tree extract, an oak gall extract, a tea extract, a wine extract, a coffee extract, or any combination thereof.

In one implementation, the concentration of the water-soluble tannin-rich material in the water-based tannin-rich treatment solution is between about 2 g/L and about 25 g/L or between about 2 g/L and about 5 g/L.

### DETAILED DESCRIPTION

The present description relates to a process for treating a wood substrate in order to obtain a colored (or altered) wood substrate, where a mineral compound that imparts the color or other desirable characteristic(s) to the wood substrate is formed in the colored or altered wood substrate. The mineral compound formed comprises the products of a chemical reaction which occurs between the wood substrate, a metal salt, and an oxygen source.

In the following description, components of the present water-based wood treatment solutions or kits, and/or steps of the process(es) described herein could be modified, simplified, altered, omitted and/or interchanged, without departing from the scope of the present disclosure, depending on the particular applications and the desired end results which the water-based wood treatment solutions or kits are intended for, as briefly exemplified herein and as also apparent to a person skilled in the art.

Furthermore, to provide a more concise description, some of the quantitative and qualitative expressions given herein may be qualified with the terms “about” and “substantially”. It is understood that whether the terms “about” and “substantially” are used explicitly or not, every quantity or qualification given herein is meant to refer to an actual given value or qualification, and it is also meant to refer to the approximation to such given value or qualification that would reasonably be inferred based on the ordinary skill in the art, including approximations due to the experimental and/or measurement conditions for such given value.

Also, the following terms have the following designated definitions, unless the context clearly indicates otherwise. All percentages referred to will be expressed in weight percent (%), based on total weight of the water-based wood treatment solution(s), water-based tannin-rich treatment solution, or components involved, unless specified otherwise. The following abbreviations are used herein: g=grams, L=liters. Unless otherwise specified, ranges listed are to be read as inclusive and combinable and temperatures are in degrees Celsius (° C.).

Additionally, as used herein, “wood,” “wood material” and/or “wood substrate” shall mean all forms of wood, for example, solid wood (such as timber or lumber in the form of logs, beams, planks, sheets, boards, etc.), wood composite materials (such as wood fiber board, chip board, particle board, etc.) and all products made from wood and wood-composite materials.

It is also noted that, in describing embodiments, specific terminology is employed for the sake of clarity. However, the description is not intended to be limited to the specific terminology so selected, and it is to be understood that each specific element or component includes all technical equivalents which operate in a similar manner to accomplish a similar purpose. For the sake of simplicity, this description principally addresses application to wood substrates.

The present disclosure describes processes, water-based wood treatment solutions, water-based tannin-rich treatment solutions and kits for treating wood substrates which, by virtue of their compositions, components and/or steps, overcome or at least minimize some of the above-discussed drawbacks.

As it will be described in more details below, a water-soluble metal (II) salt and a water-soluble acetate salt dissolved in an aqueous solvent can be incorporated into, or applied to, the wood substrate by treatment methods that contact the wood substrate with the water-based wood treatment solution obtained. The treatment also involves a water-soluble tannin-rich material that is dissolved in the aqueous solvent together with the water-soluble metal (II) salt and the water-soluble acetate salt or, alternatively, a separate water-based tannin-rich treatment solution that includes the water-soluble tannin-rich material dissolved in a distinct aqueous solvent, as described in more details below. The water-based tannin-rich treatment solution can be used as a pre-treatment or post-treatment to the water-based wood treatment solution by being incorporated into, or applied to, the wood substrate by similar treatment methods.

### Process for Treating a Wood Substrate

### Metal (II) Salt and Acetate Salt

According to a non-limitative embodiment, a process for treating a wood substrate which involves a water-based wood treatment solution is disclosed. The process includes a step of dissolving a water-soluble metal (II) salt and a water-soluble acetate salt in an aqueous solvent to obtain a water-based wood treatment solution with concentrations of the water-soluble metal (II) salt and the water-soluble acetate salt high enough to color the wood substrate. The aqueous solvent can be provided in a sufficient amount to completely (or almost completely) dissolve the water-soluble metal (II) salt and the water-soluble acetate salt, and to maintain them in solution. A sufficient amount of the water-based wood treatment solution obtained can thus be contacted with the wood substrate so that the wood substrate can be colored (e.g., to obtain a brownish, blackish or grayish wood substrate). Indeed, the water-based wood treatment solution needs to be applied to the wood substrate in a sufficient amount so that at least a portion of the wood fibers present in the wood substrate are contacted with the water-based wood treatment solution. For example, the wood fibers present at the surface of the wood substrate can be impregnated or saturated with the water-based wood treatment solution. The coloration is obtained by allowing the water-soluble metal (II) salt, the water-soluble acetate salt and the wood substrate to chemically react so as to fix or bond the reaction products to or within the wood substrate.

In some implementations, the water-soluble metal (II) salt can include, without limitation, iron salts (ferrous or ferric), such as iron chloride salts, iron bromide salts, iron fluoride salts, iron iodide salts, iron nitrate salts, iron borate salts, iron phosphate salts, iron pyrophosphate salts, iron carbonate salts, iron sulfate salts, iron titanate salts, chromates, silicates, halides, perchlorates, permanganates, thiosulfates, and the like. Oxides that are subject to reduction to release a metal ion capable of reacting with the oxygen source in the presence of the wood substrate to produce a color can also be used, so long as the metal ion or compound is sufficiently soluble to penetrate the wood substrate and is able to react with the oxygen source present in the water-based wood treatment solution to produce the desired mineral compound (i.e., the color). Other suitable water-soluble iron salts can include, without limitation, organic acid salts, such as acetate, formate, propionate, stearate, benzoate, citrate, D-gluconate, lactate and tartrate. The iron salt can include “mixed” salts of any of the aforementioned anionic counterions. In some implementations, the iron salt can be selected from one or more of chloride, bromide, nitrate and sulfate salts. In some implementations, the water-soluble wood treatment solution can include a combination of a plurality of water-soluble metal (II) salts.

In some implementations, another metal salt can be involved. For example, the metal salt can be, without limitation, a salt of silver, cerium, copper, magnesium, molybdenum, nickel, tin, chromium, any combination, and the like, or a salt of, without limitation, antimony, beryllium, bismuth, cadmium, cobalt, gold, iridium, lead, manganese, mercury, niobium, osmium, platinum, plutonium, potassium, rhodium, selenium, silicon, sodium, tantalum, thorium, tungsten, uranium, vanadium, any combination and the like, as long as the metal salt can impart a desirable color to the wood substrate, once it has chemically reacted with both the wood components and the oxygen source.

Additional suitable water-soluble iron salts can include salts formed by interaction with organic compounds, such as complexed or chelated iron salts. Suitable organic ligands that form complexes or chelates with ferric or ferrous ions include, for example, aromatic amines (such as 2,2′-bipyridine or 2,2′-dipyridyl, 1,10-phenanthroline and naphthyridine), polyamines (such as ethylenediamine and diethylenetriamine) and anionic nucleophilic compounds (such as acetylacetonate, oxalate, catecholate, thiophenoxide, cyanide (CN⁻), nitrilotriacetic acid and salts thereof, and ethylenediaminetetraacetic acid and salts thereof).

In a non-limitative embodiment, the water-soluble metal (II) salt can be, without limitation, iron (II) chloride, iron (II) perchlorate, iron (II) sulfate, copper (II) chloride, copper (II) perchlorate, tin (II) sulfate, manganese (II) chloride, titanium (II) sulfate, any combination, and the like. More particularly, the water-soluble metal (II) salt can be, without limitation, iron sulfate (FeSO₄) such as iron sulphate heptahydrate (FeSO₄.7H₂O), iron sulphate monohydrate (FeSO₄.H₂O), ethylenediammonium sulfate ((CH₂NH₃)₂SO₄. FeSO₄.4H₂O), and the like.

In some implementations, the concentration of the water-soluble metal (II) salt in the water-based wood treatment solution can be between about 1 g/L and about 10 g/L (w/v) between about 1.5 g/L and about 7 g/L, or between about 2 g/L and about 5 g/L. More particularly, the concentration of the water-soluble metal (II) salt in the water-based wood treatment solution can be between about 2 g/L and about 3 g/L.

In some implementations, the water-soluble acetate salt can be any water-soluble acetate salt capable of penetrating the wood substrate and reacting with the water-soluble metal (II) salt to impart a stable color to the wood substrate. In some implementations, the water-soluble wood treatment solution can include a combination of a plurality of water-soluble acetate salts.

In a non-limitative embodiment, the water-soluble acetate salt can be, without limitation, sodium acetate (C₂H₃NaO₂), such as sodium acetate trihydrate (CH₃COONa.3H₂O), calcium diacetate x—hydrate ((CH₃COO)₂Ca.xH₂O), and the like.

In some implementations, the concentration of the water-soluble acetate salt in the water-based wood treatment solution can be between about 1 g/L and about 10 g/L (w/v), between about 1.5 g/L and about 7 g/L, or between about 2 g/L and about 5 g/L. More particularly, the concentration of the water-soluble acetate salt in the water-based wood treatment solution can be between about 2 g/L and about 3 g/L. It is noted that the concentrations of the water-soluble metal (II) salt and of the water-soluble acetate salt present in the water-based wood treatment solution can depend on a variety of factors, including, without limitation, the species, size, type, form and other characteristics of the wood substrate or wood product to be treated as well as the intended end use of the treated or colored wood substrate.

In a non-limitative embodiment, the water-based wood treatment solution is an aqueous solution comprising between about 2 g/L and 10 g/L (w/v) of the water-soluble metal (II) salt and between about 1 g/L and 10 g/L (w/v) of the water-soluble acetate salt.

In some implementations, a different oxygen source can be involved.

### Acid

In accordance with a non-limitative embodiment, the process can further include dissolving a water-soluble acid in the aqueous solvent, together with the water-soluble metal (II) salt and the water-soluble acetate salt, prior to contacting the wood substrate with the water-based wood treatment solution. In one implementation, the nature and concentration of the water-soluble acid added in the aqueous solvent can be such as to provide the water-based wood treatment solution with a pH of between about 4 and about 7, of between about 5 and about 6, or of between about 4 and about 5. A more acidic water-based wood treatment solution can give a lighter and less uniform gray color, while a more basic water-based wood treatment solution can increase the amount of precipitate and can reduce the coloring effect on the wood substrate. The water-soluble acid can act as a pH regulator. It can keep the oxidation state at +2, which allows the organometallic complex to be completely dissolved, as it slows down the oxidation of the metal (II) salt. It also prevents the formation of precipitates.

In some implementations, the water-soluble acid can be an acid in solid form. In a non-limitative embodiment, the water-soluble acid can be sulfuric acid (H₂SO₄), acetic acid (CH₃COOH), citric acid (C₆H₈O₇), and more particularly, anhydrous citric acid.

For example, the concentrations of the water-soluble acid, the water-soluble metal (II) salt and the water-soluble acetate salt can be so as to obtain a molar ratio of acid:metal:acetate of between about 1:3:6 and about 1:3:30.

### Tannin-Rich Material

As it will be described in more details below, the coloring of the wood substrate is predominantly a result of the chemical reaction between the water-soluble metal (II) salt and the wood phenolic compounds, such as tannins, present in the wood substrate. The content of tannins present in the wood substrate can thus affect the resultant color change. Therefore, the process further includes dissolving a water-soluble tannin-rich material in the aqueous solvent, together with the water-soluble metal (II) salt and the water-soluble acetate salt, and optionally, the water-soluble acid, prior to contacting the wood substrate with the water-based wood treatment solution. Wood substrates with low or no content of tannins can therefore be colored efficiently. In some implementations, the water-soluble tannin-rich material can have a tannin content higher than about 40%, higher than about 50%, higher than about 60%, higher than about 70%, higher than about 80%, or higher than about 90%.

In some implementations, the water-soluble tannin-rich material can include epigallocatechin gallate, catechol, gallotannin and the like. In a non-limitative embodiment, the water-soluble tannin-rich material can include a logwood tree extract, a mimosa tree extract, an oak gall extract, and the like. In a non-limitative embodiment, the water-soluble tannin-rich material can further include a tea extract, such as a black tea extract and a green tea extract, a wine extract, a coffee extract, and the like.

In some implementations, the concentration of the water-soluble tannin-rich material can be between about 2 g/L and about 100 g/L, or between about 2 g/L and about 50 g/L in the water-based wood treatment solution.

Instead of being dissolved in the aqueous solvent with the water-soluble metal (II) salt and the water-soluble acetate salt, it is noted that the water-soluble tannin-rich material can be dissolved in a separate aqueous solvent so as to obtain a separate water-based tannin-rich treatment solution which can be contacted with the wood substrate before or after contacting the wood substrate with the water-based wood treatment solution, as a pre-treatment or post-treatment. In accordance with a non-limitative embodiment, the process for treating the wood substrate can involve the water-based tannin-rich treatment solution, acting as a pre-treatment solution, as well as a water-based wood treatment solution to be applied in a subsequent stage of the treatment. According to this scenario, the process can include a step of dissolving a water-soluble metal (II) salt and a water-soluble acetate salt, and optionally a water-soluble acid, in a first aqueous solvent to obtain a water-based wood treatment solution with concentrations of the water-soluble metal (II) salt and the water-soluble acetate salt high enough to color the wood substrate. The process can further include a step of dissolving a water-soluble tannin-rich material in a second aqueous solvent to obtain a water-based tannin-rich treatment solution with a concentration of the water-soluble tannin-rich material high enough to at least partially saturate the wood substrate. The process can thus include a step of contacting the wood substrate with sufficient amounts of the water-based tannin-rich treatment solution and of the water-based wood treatment solution obtained. In one scenario, the concentration of the water-soluble tannin-rich material can be between about 2 g/L and about 25 g/L, or between about 2 g/L and about 5 g/L in the water-based tannin-rich solution.

To obtain the water-based wood treatment solution, measured amounts of the water-soluble metal (II) salt and the water-soluble acetate salt are mixed or dissolved in a volume of the first aqueous solvent (e.g., in a volume of water). To obtain the water-based tannin-rich treatment solution, a measured amount of the water-soluble tannin-rich material is mixed or dissolved in a volume of the second aqueous solvent (e.g., in a volume of water). Alternatively, a measured amount of the water-soluble acid can be dissolved together with the water-soluble metal (II) salt and the water-soluble acetate salt into the first aqueous solvent.

As mentioned above, in some implementations, the wood substrate can be contacted first with the water-based tannin-rich treatment solution, as a pre-treatment step, to at least partially saturate the wood substrate and obtain a pretreated wood substrate, and then, the pretreated wood substrate can be contacted with the water-based wood treatment solution to color the wood substrate so as to obtain the colored wood substrate. By applying the water-based tannin-rich treatment solution first on the wood substrate, the tannin content of the wood substrate can increase and the reaction between the wood substrate, the water-soluble metal (II) salt and the water-soluble acetate salt can be favored to form the mineral compound on, or within, the wood substrate, once the water-based wood treatment solution has been applied thereon. It is further noted that different colors, darker colors for example, can be obtained by contacting the obtained colored wood substrate a second time with the water-based tannin-rich treatment solution, as a post-treatment step.

The water-based tannin-rich treatment solution can be applied to the wood substrate in a sufficient amount to at least partially saturate the wood substrate, while the water-based wood treatment solution can be applied to the wood substrate or the pre-treated wood substrate in a sufficient amount to react with the wood substrate and/or the water-soluble tannin-rich material applied to the wood substrate so as to color the wood substrate. For example, the wood substrate can be contacted with the water-based tannin-rich treatment solution and the water-based wood treatment solution for contact time periods sufficient so that at least a portion of the wood fibers present in the wood substrate are contacted with the water-based tannin-rich treatment solution and the water-based wood treatment solution. For example, the wood fibers present at the surface of the wood substrate can be impregnated and saturated with the water-based tannin-rich treatment solution and the water-based wood treatment solution, respectively.

Conversely, in some implementations, the wood substrate can be contacted with the water-based wood treatment solution (i.e., with the water-soluble metal (II) salt and the water-soluble acetate salt) first, to obtain a pretreated wood substrate, and then the pretreated wood substrate can be contacted with the water-based tannin-rich treatment solution containing the water-soluble tannin material, as a post-treatment step, so as to obtain the desired colored wood substrate. Therefore, the order in which these water-based tannin-rich treatment and water-based wood treatment solutions are applied on the wood substrate can lead to different coloring effects.

In other scenarios, the wood substrate can be contacted according to different treatment stages with a first solution which contains the water-soluble tannin-rich material, with a second solution which contains the water-soluble metal (II) salt and, with a third solution which contains the water-soluble acetate salt (or directly with the water-soluble acetate salt), as long as the chemical interaction can occur between the wood substrate (and the recently applied tannins or water-soluble tannin-rich material), the water-soluble metal (II) salt and the water-soluble acetate salt, and can allow the water-soluble metal (II) salt and the water-soluble acetate salt to form the mineral compound on, and/or within, the wood substrate.

It is further noted that different wood substrates, different water-soluble metal (II) salts, different water-soluble acetate salts, different water-soluble acids and different water-soluble tannin-rich materials can be involved in providing the wood substrate with different coloring effects.

### Aqueous Solvent

In one implementation, the aqueous solvent(s) can be water. It is noted that the water-based wood treatment solution and the water-based tannin-rich treatment solution can involve other solvent than substantially liquid aqueous solvent. For example, a water-based gel, a water-based paste, a water-based emulsion, or other thick water-based preparation can be used as the aqueous solvent(s), as long as such preparation is capable of delivering the water-soluble metal (II) salt, the water-soluble acetate salt (i.e., the oxygen source), and the water-soluble tannin-rich material, into or on the wood substrate so that the water-soluble metal (II) salt, the water-soluble acetate salt, the water-soluble tannin-rich material and the wood components can react to form the mineral compound (i.e., the grayish color).

### Additives

It is also noted that the water-based wood treatment solution or the water-based tannin-rich treatment solution described above can further include a compatible additive selected from the group consisting of, without limitation, thickener, alcohol, emulsifier, additional coloring agent, additional pigment, additional dye, bleach, sealer, finishing agent, tint, acrylic finish, latex finish, polyurethane, gelling agent, surfactant, buffer, base, additional color, additional salt, stabilizer, antimicrobial agent, antifungal agent, insecticide, insect repellant, ultraviolet protectant, fire retardant, and the like. Other suitable additives can be employed as long as they do not interfere with the chemical reaction that occurs between the wood components, the water-soluble metal (II) salt, the water-soluble tannin-rich material and/or the water-soluble acid.

### Form of the Components

In some implementations, the water-soluble metal (II) salt, the water-soluble acetate salt, the water-soluble tannin-rich material and/or the water-soluble acid can be provided in solid form (e.g., in a powder form, in tablets, etc.), while in some other implementations, the water-soluble metal (II) salt, the water-soluble acetate salt, the water-soluble tannin-rich material and/or the water-soluble acid can come in a concentrated liquid solution and can be diluted with the aqueous solvent(s) to form the water-based wood treatment solution or, alternatively, the water-based wood treatment solution and the water-based tannin-rich treatment solution. The water-soluble metal (II) salt and the water-soluble acetate salt can be added substantially simultaneously (i.e., at the same time) in the aqueous solvent. Alternatively, the water-soluble metal (II) salt and the water-soluble acetate salt can be introduced in the aqueous solvent one after the other, and in any order. The water-soluble metal (II) salt, the water-soluble acetate salt, the water-soluble tannin-rich material and/or the water-soluble acid can further be provided in separate and fully diluted liquid containers, ready to be mixed together to then be applied on a wood substrate. Indeed, it remains important that at least the water-soluble metal (II) salt and the water-soluble acetate salt remain in different compartments prior they are mixed together, so the reaction not only occurs between these two species, but together with the tannins of the wood substrate, increasing the coloring results.

### Contact Between Water-Based Wood Treatment Solution and Wood Substrate

Suitable methods for contacting the wood substrate with the water-based wood treatment and tannin-rich solutions can include, without limitation, immersion, brushing, spraying, rolling, dipping, pressure treatments (e.g., pressure impregnation), and the like. In some implementations, such methods can be used for contacting the wood substrate with the water-based wood treatment and with the water-based tannin-rich treatment solution, before its use in wooden structures and products. However, already built-in wood (e.g. flooring, cladding, etc.) can also be contacted with the water-based wood treatment solution and the water-based tannin-rich treatment solution using such techniques.

### Operating Conditions

### Temperature

The wood substrate can be contacted with the water-based wood treatment solution and the water-based tannin-rich treatment solution at temperatures ranging from about 4° C. to about 100° C. More particularly, the wood substrate can be contacted with the water-based wood treatment solution and the water-based tannin-rich treatment solution at temperatures ranging from about 10° C. to about 50° C. In one implementation, the wood substrate can be contacted with the water-based wood treatment solution and the water-based tannin-rich treatment solution at room temperature. In some implementations, the water-based wood treatment solution and the water-based tannin-rich treatment solution can be applied to the wood substrate at a temperature which is found to be between the freezing point and the boiling point of the obtained water-based wood treatment solution and the water-based tannin-rich treatment solution. In order to help dissolve the components in the aqueous solvent, the aqueous solvent can optionally be heated prior introduction of the components therein. For example, the aqueous solvents can be heated to a temperature of between about 40° C. and about 90° C., or between about 60° C. and 80° C. prior dissolving the water-soluble metal (II) salt, the water-soluble acetate salt, the water-soluble tannin-rich material and optionally, the water-soluble acid therein.

Once applied on the wood substrate, the water-based wood treatment solution and the water-based tannin-rich treatment solution can be allowed to dry, under room conditions for example. An air stream (which can be heated or not) can optionally be involved in drying the wood substrate with the water-based wood treatment solution and the water-based tannin-rich treatment solution applied thereon. In some implementations, the wood substrate can be contacted with the water-based tannin-rich treatment solution in order to form a first layer of the water-based tannin-rich treatment solution, once it has dried on the wood surface. Another or other layer(s) can be formed on the wood substrate with the water-based tannin-rich treatment solution and/or water-based wood treatment solution.

### Pressure

In one implementation, contacting the wood substrate with the water-based wood treatment solution and the water-based tannin-rich treatment solution can be performed at atmospheric pressure. Alternatively, use of vacuum-pressure or other techniques can further be used to reduce treatment time and increase the level of penetration of the water-based wood treatment solution and the water-based tannin-rich treatment solution into the wood substrate or wood products, thereby increasing the effectiveness of the wood treatment (i.e., of the coloring treatment).

### Application Period

In a non-limitative implementation, the water-based wood treatment solution obtained needs to be applied on the wood substrate in a predetermined period of time (i.e., before a predetermined amount of time), just after the water-soluble metal (II) salt and the water-soluble acetate salt have been dissolved in the aqueous solvent, so that the reaction does not only occur in the water-based wood treatment solution containing the metal (II) salt and the acetate salt, but also, together with the wood components (e.g., the tannins) and/or the tannins of the water-based tannin-rich treatment solution.

In a non-limitative implementation, the water-based tannin-rich treatment solution obtained needs to be applied on the wood substrate in a predetermined period of time (i.e., before a predetermined amount of time), just after the water-soluble tannin-rich material has been dissolved in the aqueous solvent. For example, the application of the water-based tannin-rich treatment solution can be performed on the wood substrate before 6 months, before 1 month, or before 4 weeks after the water-soluble tannin-rich material has been dissolved in the aqueous solvent.

### Preventing Contact of Some Components

In a non-limitative implementation, direct contact of the water-soluble metal (II) salt with the water-soluble acetate salt needs to be prevented prior to dissolving the water-soluble metal (II) salt and the water-soluble acetate salt in the aqueous solvent, so that no reaction occurs between these components prior to dissolution of these components and thus, prior to application of the water-based wood treatment solution on the wood substrate. In other words, at least the water-soluble metal (II) salt and the water-soluble acetate salt can be kept apart from each other before mixing them in the aqueous solvent, otherwise, these components can react or melt together, and produce a water-based wood treatment solution unable to provide the desired coloring or aging effect to the wood substrate.

### Pre-Treatment

So that the water-based wood treatment solution can efficiently penetrate the wood substrate (i.e., it can reach a maximum depth), prior to contacting the wood substrate with the water-based wood treatment solution and/or with the water-based tannin-rich treatment solution, the wood substrate can be washed, sandblasted, prepared, etc.

### Post-Treatment

In some implementations, the colored wood substrate obtained can receive a final surface treatment. For example, final or polishing solution(s) can be applied on the colored wood substrate. Indeed, oils, varnishes, waxes, paints, etc. can be applied on the colored wood substrate obtained.

### Wood Substrate

In some implementations, the wood substrate can be selected from wood species such as, without limitation, white cedar, red cedar, white spruce, fir, balsam fir, white pine, red pine, aspen or trembling aspen, silver maple, larch, walnut, white birch, sweet cherrywood, red oak, white ash, black ash, ipe, brazilwood, sour cherrywood, quaking aspen, and the like. In some implementations, the wood substrate to be treated can have a moisture content of less than 20%. However, in some implementations, the wood substrate to be treated can have a moisture content between about 20% and about 100%. Therefore, it is not required that the wood substrate be completely dried before treating it with the water-based wood treatment solution and/or with the water-based tannin-rich treatment solution.

### Water-Based Wood Treatment Solution and Water-Based Tannin-Rich Treatment Solution

In accordance with another non-limitative embodiment, a water-based wood treatment solution for treating a wood substrate is disclosed. The water-based wood treatment solution includes a water-soluble metal (II) salt, a water-soluble acetate salt, a water-soluble tannin-rich material and an aqueous solvent to obtain the water-based wood treatment solution with concentrations of the water-soluble metal (II) salt, the water-soluble acetate salt and the water-soluble tannin-rich material high enough to at least partially saturate and color the wood substrate, as described above. Again, in some implementations, the water-based wood treatment solution can further include a water-soluble acid.

In accordance with a further non-limitative embodiment, a water-based wood treatment solution and a water-based tannin-rich treatment solution for treating a wood substrate are disclosed. The water-based wood treatment solution includes a water-soluble metal (II) salt, a water-soluble acetate salt and a first aqueous solvent to obtain the water-based wood treatment solution with concentrations of the water-soluble metal (II) salt and the water-soluble acetate salt high enough to color the wood substrate, as described above. In some implementations, the water-based wood treatment solution can further include a water-soluble acid. On the other hand, the water-based tannin-rich treatment solution includes a water-soluble tannin-rich material and a second aqueous solvent to obtain the water-based tannin-rich treatment solution with concentration of the water-soluble tannin-rich material high enough to at least partially saturate the wood substrate, prior or after it has been contacted with the water-based wood treatment solution.

### Kit for Treating a Wood Substrate

In accordance with another non-limitative embodiment, there is provided a kit for treating a wood substrate. The kit comprises a pouch which comprises a water-soluble metal (II) salt in solid form, a pouch which comprises a water-soluble acetate salt in solid form, a pouch which comprises a water-soluble tannin-rich material in solid form and a user guide which provides instructions for dissolving a dose of the water-soluble metal (II) salt and a dose of the water-soluble acetate salt in an amount of an aqueous solvent to thereby obtain a water-based wood treatment solution having a concentration of water-soluble metal (II) salt and water-soluble acetate salt sufficient to allow the water-based wood treatment solution to color the wood substrate. The user guide further provides instructions for dissolving a dose of the water-soluble tannin-rich material in the aqueous solvent along with the water-soluble metal (II) salt and the water-soluble acetate salt. The user guide alternatively provides instructions for dissolving a dose of the water-soluble tannin-rich material in another (in a second) aqueous solvent to thereby obtain a separate water-based tannin-rich treatment solution having a concentration of water-soluble tannin-rich material sufficient to allow the water-based tannin-rich treatment solution to at least partially saturate the wood substrate. The pouch can be a container envelop or the like and has a predetermined amount of a water-soluble metal (II) salt, a water-soluble acetate salt or a water-soluble tannin-rich material. The kit can further include a pouch which comprises a water-soluble acid in solid form, and the user guide can further provides instructions for dissolving a dose of the water-soluble acid in the aqueous solvent along with the water-soluble metal (II) salt and the water-soluble acetate salt so as to adjust the pH of the water-based wood treatment solution. The water-soluble acid can indeed slow down the chemical reaction and prevent the water-based wood treatment solution from precipitating.

The water-soluble metal (II) salt and the water-soluble acetate salt can be dissolved substantially simultaneously, or subsequently, in the aqueous solvent to obtain the water-based wood treatment solution with concentrations of the water-soluble metal (II) salt and the water-soluble acetate salt high enough to color the wood substrate. At least the pouches containing the water-soluble metal (II) salt and the water-soluble acetate salt can be hermetic (i.e., airtight), so that the water-soluble metal (II) salt and the water-soluble acetate salt do not react with air or oxygen prior to being dissolved in their aqueous solvent.

### Chemical Reactions

As mentioned above, the water-soluble metal (II) salt can be iron sulfate, while the water-soluble acetate salt can be sodium acetate. The mixture of iron sulfate in the aqueous solvent is believed to create ferrous acetate. Ferrous acetate formed, which is soluble in water, is slowly oxidized by oxygen, present in sodium acetate salt, to ferric acetate. Ferrous acetate (or ferric acetate) is believed to accelerate the oxidation of components such as lignin and tannins, which are present in the wood substrate. These two components are composed, among other, of numerous phenol groups. The purpose of the metal (II) salt is therefore to accelerate the oxidation of the lignin and the tannins present in the wood substrate, while the main objective of the acetate salt is to favor penetration of the solution into the wood.

Indeed, the water-soluble metal (II) salt and the water-soluble acetate salt are dissolved in the aqueous solvent and applied on the wood substrate to penetrate or impregnate it. They react together, and with the wood components, and the water-soluble tannin-rich material, to produce the mineral compound which will be affix on the external surface of the wood substrate, and/or within the wood substrate. Impregnation of the water-soluble metal (II) salt and the water-soluble acetate salt into the wood substrate is therefore accomplished by use of the aqueous solvent. The combination of mutually compatible water-soluble metal (II) salt, water-soluble acetate salt, water-soluble tannin-rich material and wood substrate brings about an in situ reaction, and modifies the wood substrate to provide it with the desired coloring effect.

The mineral compound that is produced by contacting with the wood substrate the water-based wood treatment solution containing the water-soluble metal (II) salt, the water-soluble acetate salt and the water-soluble tannin-rich material (or alternatively by contacting with the wood substrate the water-based wood treatment solution containing the water-soluble metal (II) salt and the water-soluble acetate salt, and the water-based tannin-rich treatment solution containing the water-soluble tannin-rich material) is linked to the wood substrate, is stable and long-lasting or permanent, and is immobilized or insolubilized in the wood substrate. As mentioned above, a wide variety of water-soluble metal (II) salts, water-soluble acetate salt, water-soluble tannin-rich material and/or wood substrate can be used depending on the desired coloring effect. The process(es) defined thus allow a water-soluble metal (II) salt and a water-soluble acetate salt to react with the wood substrate and the water-soluble tannin-rich material applied thereon to provide a stable color effect, while preserving the integrity of the wood substrate.

Upon application of the water-based wood treatment solution (or water-based wood treatment solution and water-based tannin-rich treatment solution) on the wood substrate, the chemical reaction occurs between the tannin phenols, which are present in the wood substrate, and optionally in the water-soluble tannin-rich material. Indeed, the tannin phenols allow chelation of the metal ions. The water-soluble metal (II) salt, depending on its concentration and the pH of the wood substrate to be treated or colored, will change the color of the phenols contained in the wood substrate. The reaction is accelerated by the presence of oxygen present in the water-soluble acetate salt and the aqueous solvent. The treatment process therefore allows the color modification of the wood substrate using the chemical reaction between the wood phenolic compounds, such as tannins present in the wood substrate, and the water-soluble metal (II) salt forming the water-based wood treatment solution.

Although the process is not intended to be limited to the mechanism of action, it is believed that the oxygen present in the water-soluble acetate salt causes an oxidation reaction, bonding the water-soluble metal (II) salt to or among the cellulose fibers present in the wood substrate, a process referred to here as “crosslinking”. The chemical nature of the crosslinking reaction is suggested by the fact that a color change results from the combination of the water-soluble metal (II) salt and the water-soluble acetate salt both present in the water-based wood treatment solution, and the wood substrate. The resulting color, unlike the water-based wood treatment solution and its components, is not water-soluble.

The process therefore involves saturating the fibers of the wood substrate with the water-soluble metal (II) salt present in the water-based wood treatment solution in a water-soluble form and then, oxidizing the water-soluble metal (II) salt in the fibers of the wood substrate to change the color, texture, and/or general appearance of the wood substrate. The water-based wood treatment solution containing the water-soluble metal (II) salt soaks into the wood substrate, impregnating it with mineral ions, which are then converted by the oxygen source (i.e., the water-soluble acetate salt) into an insoluble coloring compound.

By contacting the wood substrate with the water-based wood treatment solution (or water-based wood treatment solution and water-based tannin-rich treatment solution) defined above, the wood substrate gets a darker shade (e.g., a gray shade), while its natural texture and general integrity are preserved (e.g., the treatment does not affect the strength of the wood substrate bonded joints.), so it can aesthetically resemble the desired aged wood substrates.

As mentioned, the content of phenolic compounds such as tannins present in the wood substrate and alternatively water-soluble tannin-rich material can affect the resultant color change. Therefore, upon contact of the wood substrate with the treatment solution (or pre-treatment and treatment solutions), wood substrates with high contents of phenolic compounds can darken considerably, while wood substrates with low contents of phenolic compounds can darken slightly.

The processes, water-based wood treatment solution, water-based tannin-rich treatment solution and kits described above can satisfy a need for a water-based, non-toxic wood treatment that provides a substantially permanent even coloring or aging effect to the wood substrate.

While the prior art wood treatment processes present many drawbacks, the treatment processes described above allow to rapidly obtain coloring results, while emitting no other and preventing the treatment solutions to precipitate once the components (at least the water-soluble metal (II) salt and water-soluble acetate salt) have been introduced into the aqueous solvent. The mixture of the components into the aqueous solvent creates an oxidizing treatment for the wood substrate, instantly, which has known concentrations. An easy industrial scaling can therefore be performed.

As mentioned above, almost instantly after the water-based wood treatment solution has been applied on the wood substrate, the wood substrate is altered to obtain a grayish color, which mimics the appearance of an aged wood substrate. Depending on the species of the wood substrate to be treated, the color obtained can vary from light gray to dark gray, or can be silver gray, as the oxidation reaction occurring between the wood substrate (and the water-soluble tannin-rich material), the water-soluble metal (II) salt and the water-soluble acetate salt will depend on the concentration of tannins, and on the degradation rate of the tannins present on, or within, the wood substrate. The present water-based wood treatment solution and water-based tannin-rich treatment solution thus allow the graying of young wood substrates to mimic the look of a weathered piece of barn wood, for example, while retaining the original quality of the wood, by accelerating the natural oxidation of the wood substrate. The color modification occurs substantially instantly, while it can take several weeks, months or years to obtain similar results under natural oxidizing conditions, UV rays and/or weather conditions.

The need for volatile organic solvents and toxic compounds is also avoided. Moreover, heating or pressurizing steps can be employed prior, during and/or after application of the solutions, but are not required to obtain the desired end results. The treatment process is thus simple enough to be used by an amateur.

The water-based wood treatment solution and the water-based tannin-rich treatment solution described are completely water-based. The process does not require a binder of any kind, petroleum products, organic solvents, acrylic resins, dyes, or other expensive or toxic materials. The component materials have low-impact on both the environment and human health. The unique characteristics of these treatment solutions, their permanence even in exterior applications, their ability to evenly stain extremely soft woods and penetrate extremely hard woods, their simulated aging of wood, and the richness of the colors achieved can appeal even to those completely unconcerned about its environmental and health advantages.

It is noted that contacting the wood substrate with the water-based wood treatment solution, and alternatively, water-based tannin-rich treatment solution, can also impart other chemical or physical effects to the wood substrate.

### Experiments and Results

Different combinations of water-soluble metal (II) salt, of water-soluble acetate salt, of water-soluble tannin-rich material and of water-soluble acid were tested to obtain suitable water-based wood treatment solutions and/or water-based tannin-rich solutions. Wood substrates were contacted with the obtained water-based wood treatment solutions and/or water-based tannin-rich solutions and coloring results were assessed.

### Experiment No. 1

The water-based wood treatment solution was prepared according to the following steps. 1 Liter of water was heated to about 60° C.-80° C. 2.78 g of iron sulphate heptahydrate (FeSO₄.7H₂O, green powder) (34.4%), 2.72 g of sodium acetate trihydrate (NaC₂H₃O₂.3H₂O, white crystals) (33.7%), 0.58 g of anhydrous citric acid (C₆H₈O₇ anh.) (7.2%) and 2 g of logwood tree extract (hematoxylin) (24.8%), all in the powder form, were dissolved in the heated water. It is noted that the sodium acetate trihydrate can be dissolved in water prior to dissolving the iron sulphate heptahydrate so as to facilitate its dissolution. The obtained water-based wood treatment solution turned black without precipitating. It was then applied on a White Birch wood using a paintbrush.

The water-based wood treatment solution was allowed to dry on the wood for about 30-45 minutes. The wood was provided with a light gray color only after few minutes. It is noted that the powders remained separated before their dissolution into water. Also, it is noted that the obtained water-based wood treatment solution has a shelf life of about 1 week, if conserved in a hermetic, and non-metallic environment.

### Experiment No. 2

A water-based wood treatment solution was prepared according to the following steps. 2.78 g of iron sulphate heptahydrate (FeSO₄.7H₂O) (45.7%), 2.72 g of sodium acetate trihydrate (NaC₂H₃O₂.3H₂O) (44.7%) and 0.58 g of anhydrous citric acid (C₆H₈O₇ anh.) (9.6%), all in the powder form, were dissolved in 1 L of water. Another liter of water was heated to about 60-80° C., and a water-based tannin-rich treatment solution was obtained by dissolving 2 g of logwood tree extract (hematoxylin) (100%) in the heated water. The obtained water-based wood treatment solution containing iron sulfate, sodium acetate and citric acid turned pale yellow without precipitating, while the water-based tannin-rich treatment solution containing the logwood tree extract turned reddish brown. Over time and under exposure to air, the yellowish water-based wood treatment solution oxidized and turned orange (without precipitating). The water-based tannin-rich treatment solution was applied on a white birch wood using a paintbrush. The water-based tannin-rich treatment solution was allowed to dry on the wood for about 30 minutes. Then, the water-based wood treatment solution was applied on the pretreated white birch wood with the paintbrush. The water-based wood treatment solution was allowed to dry on the wood for about 45 minutes. The wood was provided with a gray color only after few minutes. It is noted that the powders remained separated before their dissolution into water. Also, it is noted that the obtained water-based wood treatment solution has a shelf life of about 1 year, if conserved in a hermetic, and non-metallic environment.

The color tone or finish varies with the chosen wood species that were treated and the chosen treatment process (water-based tannin-rich treatment solution applied as the pretreatment step or together with the water soluble metal (II) salt and the water-soluble acetate salts of the water-based wood treatment solution).

Reactions (and resultant color and textural appearance of the wood substrate) varies with the substrate material. In the experiments presented above, white birch was treated with the treatment solution(s). However, it is noted that other wood species were successfully treated with these treatment solutions (white cedar, red cedar, sweet cherrywood, red oak, spruce, silver maple, white ash, black ash, ipe or brazilwood, larch, sour cherrywood, white pine, red pine, fir, quaking aspen, walnut, alder, mahogany and basswood).

As mentioned, the coloring results also varies with the number of layers applied on the wood surface (or with the treatment process: water-based tannin-rich treatment solution applied as the pretreatment step or water-soluble tannin-rich material applied together with the water-soluble metal (II) salt and the water-soluble acetate salts). In general, starting with one layer of the water-based tannin-rich treatment solution (the dissolved logwood tree extract) and finishing with one or more applications of the water-based wood treatment solution yields to darker grayish colorations.

The obtained treated wood substrates have been subjected to accelerated weathering situations, exposure to sun, hot water, freezing temperatures, harsh rain conditions, etc. The wood substrates tested were found to be resistant to such conditions. These tests show that the obtained treated wood substrate or products are permanently colored and suitable for use according to interior and exterior applications.

### Other Experimentations

White cedar (Thuya occidentalis): When contacting the wood substrate with a single water-based wood treatment solution containing iron salt, sodium acetate, citric acid and logwood tree extract, the color of the wood substrate changed from yellow to gray. When contacting the wood substrate with the water-based tannin-rich treatment solution containing the logwood tree extract and then, with the water-based wood treatment solution containing iron salt, sodium acetate and citric acid, the color of the wood substrate changed from yellow to gray.

Red cedar (Thuya plicate): When contacting the wood substrate with a single water-based wood treatment solution containing iron salt, sodium acetate, citric acid and logwood tree extract, the color of the wood substrate changed from reddish to reddish-gray. When contacting the wood substrate with the water-based tannin-rich treatment solution containing the logwood tree extract and then, with the water-based wood treatment solution containing iron salt, sodium acetate and citric acid, the color of the wood substrate changed from reddish to gray.

White spruce (Picea glauca): When contacting the wood substrate with a single water-based wood treatment solution containing iron salt, sodium acetate, citric acid and logwood tree extract, the color of the wood substrate changed from yellowish-white to pale gray or dark gray. When contacting the wood substrate with the water-based tannin-rich treatment solution containing the logwood tree extract and then, with the water-based wood treatment solution containing iron salt, sodium acetate and citric acid, the color of the wood substrate changed from yellowish-white to a pale gray or dark gray of uniform tone.

Fir (Abies balsamea): When contacting the wood substrate with a single water-based wood treatment solution containing iron salt, sodium acetate, citric acid and logwood tree extract, the color of the wood substrate changed from yellowish-white to pale gray or dark gray. When contacting the wood substrate with the water-based tannin-rich treatment solution containing the logwood tree extract and then, with the water-based wood treatment solution containing iron salt, sodium acetate and citric acid, the color of the wood substrate changed from yellowish-white to a pale gray or dark gray of uniform tone.

White Pine (Pinus Strobus): When contacting the wood substrate with a single water-based wood treatment solution containing iron salt, sodium acetate, citric acid and logwood tree extract, the color of the wood substrate changed from yellow to gray or brownish gray. The variability depended on the original tone of the wood. When contacting the wood substrate with the water-based tannin-rich solution containing the logwood tree extract and then, with the water-based wood treatment solution containing iron salt, sodium acetate and citric acid, the color of the wood substrate changed from yellow to a uniformly distributed gray color.

Aspen or trembling aspen (Populus tremuloides): White Pine (Pinus Strobus): When contacting the wood substrate with a single water-based wood treatment solution containing iron salt, sodium acetate, citric acid and logwood tree extract, the color of the wood substrate changed from yellowish-white to pale gray. When contacting the wood substrate with the water-based tannin-rich treatment solution containing the logwood tree extract and then, with the water-based wood treatment solution containing iron salt, sodium acetate and citric acid, the color of the wood substrate changed from yellowish-white to a uniform distribution of a deeper tone of gray.

Silver maple (Acer saccharinum): When contacting the wood substrate with a single water-based wood treatment solution containing iron salt, sodium acetate, citric acid and logwood tree extract, the color of the wood substrate changed from yellow to silvery gray. When contacting the wood substrate with the water-based tannin-rich treatment solution containing the logwood tree extract and then, with the water-based wood treatment solution containing iron salt, sodium acetate and citric acid, the color of the wood substrate changed from yellow to a deep silvery gray.

Larch (Larix laricina): When contacting the wood substrate with a single water-based wood treatment solution containing iron salt, sodium acetate, citric acid and logwood tree extract, the color of the wood substrate changed from light brown to dark gray. When contacting the wood substrate with the water-based tannin-rich treatment solution containing the logwood tree extract and then, with the water-based wood treatment solution containing iron salt, sodium acetate and citric acid, the color of the wood substrate changed from light brown to dark gray.

Cherry (Prunus avium): When contacting the wood substrate with a single water-based wood treatment solution containing iron salt, sodium acetate, citric acid and logwood tree extract, the color of the wood substrate changed from reddish to dark gray or from yellowish to pale gray or silvery gray. When contacting the wood substrate with the water-based tannin-rich treatment solution containing the logwood tree extract and then, with the water-based wood treatment solution containing iron salt, sodium acetate and citric acid, the color of the wood substrate changed from reddish to a deeper tone of dark gray or from yellowish to a deeper tone of silvery gray.

Walnut (Junglans regia): When contacting the wood substrate with a single water-based wood treatment solution containing iron salt, sodium acetate, citric acid and logwood tree extract, the color of the wood substrate changed from dark brown to black or from pale brown to gray. When contacting the wood substrate with the water-based tannin-rich treatment solution containing the logwood tree extract and then, with the water-based wood treatment solution containing iron salt, sodium acetate and citric acid, the color of the wood substrate changed from reddish to a deeper tone of dark gray or from dark brown to black or from pale brown to gray.

Red alder (Alnus rubra): When contacting the wood substrate with a single water-based wood treatment solution containing iron salt, sodium acetate, citric acid and logwood tree extract, the color of the wood substrate changed from a rust red to gray. When contacting the wood substrate with the water-based tannin-rich treatment solution containing the logwood tree extract and then, with the water-based wood treatment solution containing iron salt, sodium acetate and citric acid, the color of the wood substrate changed from reddish to a deeper tone of dark gray.

African mahogany (Khaya ivorensis): When contacting the wood substrate with a single water-based wood treatment solution containing iron salt, sodium acetate, and citric acid, the color of the wood changed from a pink to a dark grey. When contacting the wood substrate with the water-based tannin-rich treatment solution containing the logwood tree extract and then, with the water-based wood treatment solution containing iron salt, sodium acetate and citric acid, the color of the wood substrate changed from a pink to a dark grey.

American basswood (Tilia Americana): When contacting the wood substrate with a single water-based wood treatment solution containing iron salt, sodium acetate, and citric acid, the color of the wood changed from a light beige yellow to a light grey. When contacting the wood substrate with the water-based tannin-rich treatment solution containing the logwood tree extract and then, with the water-based wood treatment solution containing iron salt, sodium acetate and citric acid, the color of the wood substrate changed from a light beige yellow to a deeper tone of silvery grey.

Although the present invention has been described hereinabove by way of specific embodiments thereof, it can be modified without departing from the spirit and nature of the subject invention defined in the appended claims.

1. A kit for treating a wood substrate, the kit comprising:
a pouch comprising a water-soluble metal (II) salt in solid form;
a pouch comprising a water-soluble acetate salt in solid form;
a pouch comprising a water-soluble tannin-rich material in solid form; and
a user guide providing instructions for dissolving a dose of the water-soluble metal (II) salt and a dose of the water-soluble acetate salt in an amount of an aqueous solvent to thereby obtain a water-based wood treatment solution having a concentration of water-soluble metal (II) salt and water-soluble acetate salt sufficient to allow the water-based wood treatment solution to color the wood substrate, and instructions:
for dissolving a dose of the water-soluble tannin-rich material in the aqueous solvent along with the water-soluble metal (II) salt and the water-soluble acetate salt; or
for dissolving a dose of the water-soluble tannin-rich material in another aqueous solvent to thereby obtain a water-based tannin-rich treatment solution having a concentration of water-soluble tannin-rich material sufficient to allow the water-based tannin-rich treatment solution to at least partially saturate the wood substrate.

2. The kit of claim 1, wherein the water-soluble metal (II) salt and the water-soluble acetate salt are provided in form of solid powders.

3. The kit of claim 1, wherein the water-soluble tannin-rich material is provided in form of solid powders.

4. The kit of claim 1, wherein at least the pouch comprising the water-soluble metal (II) salt and the pouch comprising the water-soluble acetate salt are hermetic pouches.

5. The kit of claim 1, wherein the water-soluble metal (II) salt comprises a water-soluble iron (II) salt.

6. The kit of claim 5, wherein the water-soluble iron (II) salt comprises an iron (II) chloride, an iron (II) perchlorate, an iron (II) sulfate, or any combination thereof.

7. The kit of claim 5, wherein the water-soluble iron (II) salt comprises an iron (II) sulfate monohydrate, an iron (II) sulfate heptahydrate, an iron (II) ethylenediammonium sulfate, or any combination thereof.

8. The kit of claim 7, wherein the water-soluble iron (II) salt comprises the iron (II) sulfate heptahydrate.

9. The kit of claim 1, wherein the concentration of the water-soluble metal (II) salt in the water-based wood treatment solution is between about 1 g/L and about 10 g/L, between about 1.5 g/L and about 7 g/L, between about 2 g/L and about 5 g/L or between about 2 g/L and about 3 g/L.

10. The kit of claim 1, wherein the water-soluble acetate salt comprises a sodium acetate, a calcium diacetate x-hydrate, or any combination thereof.

11. The kit of claim 10, wherein the sodium acetate comprises a sodium acetate trihydrate.

12. The kit of claim 1, wherein the concentration of the water-soluble acetate salt in the water-based wood treatment solution is between about 1 g/L and about 10 g/L, between about 2 g/L and about 5 g/L or between about 2 g/L and about 3 g/L.

13. (canceled)

14. The kit of claim 1, wherein the pH of the water-based wood treatment solution is adjusted to between about 4 and about 7, between about 5 and about 6 or between about 4 and about 5.

15. The kit of claim 1, wherein the water-soluble tannin-rich material has a tannin content greater than 40%, greater than 50%, greater than 60%, greater than 70%, greater than 80%, or greater than 90%.

16. The kit of claim 1, wherein the water-soluble tannin-rich material comprises a logwood tree extract, a mimosa tree extract, an oak gall extract, a tea extract, a wine extract, a coffee extract, or any combination thereof.

17. The kit of claim 1, wherein the concentration of the water-soluble tannin-rich material in the water-based wood treatment solution is between about 2 g/L and about 100 g/L, or between about 2 g/L and about 50 g/L.

18. The kit of claim 1, wherein the concentration of the water-soluble tannin-rich material in the water-based tannin-rich treatment solution is between about 2 g/L and about 25 g/L or between about 2 g/L and about 5 g/L.

19. The kit of claim 1, further comprising:
a pouch comprising a water-soluble acid in solid form;
wherein the user guide further provides instructions for dissolving a dose of the water-soluble acid in the aqueous solvent along with the water-soluble metal (II) salt and the water-soluble acetate salt so as to adjust the pH of the water-based wood treatment solution.

20. The kit of claim 19, wherein the molar ratio of the water-soluble acid, the water-soluble metal (II) salt and the water-soluble acetate salt in the water-based wood treatment solution is between about 1:3:6 and about 1:3:30.

21. The kit of claim wherein the water-soluble acid is provided in form of solid powders.

22. (canceled)

23. (canceled)
